(19) United States
(12) Patent Application Publication
(10) Pub. No.: US 2014/0249291 A1
(43) Pub. Date: Sep. 4, 2014

(54) METHOD OF MAKING INTEGRATED ION MEMBRANE SEALING RING ASSEMBLY

(71) Applicant: SHENZHEN JINFAN POWER CO., LTD., Shenzhen (CN)

(72) Inventors: Yijun ZHENG, Shenzhen (CN); Dongdong ZHENG, Shenzhen (CN)

(73) Assignee: SHENZHEN JINFAN POWER CO., LTD., Shenzhen (CN)

(21) Appl. No.: 14/277,272

(22) Filed: May 14, 2014

Related U.S. Application Data
(63) Continuation of application No. PCT/CN2012/081030, filed on Sep. 6, 2012.

(30) Foreign Application Priority Data
Nov. 22, 2011 (CN) 201110376948.3

(51) Int. Cl. H01M 2/16

(52) U.S. Cl. CPC H01M 2/1653
USPC 528/391

(57) ABSTRACT

A method of making a sealing ring ion membrane integrated component, includes: mixing and stirring sulfonic resin with dimethylformamide; filtering the mixed liquid; placing the filtrate in a plastic container for precipitating; the sealing ring into a worktable of a drying apparatus; pouring the precipitated filtrate into the worktable of the drying apparatus, and vacuuming while drying; and taking the dried integrated ion membrane sealing ring assembly out of the drying apparatus, and then cooling the assembly.

### FIELD

The present disclosure relates to a vanadium redox battery field, and more particularly to methods of making an integrated ion membrane sealing ring assembly used in the vanadium redox battery.

### BACKGROUND

An ion membrane surface made by a traditional method of making an ion membrane may have small wrinkles and water marks, causing the ion membrane surface to be not as flat as desired. During the use of this ion membrane, impurities may easily accumulate in a wrinkled part of the ion membrane. These impurities may reduce the lifetime of the ion membrane, affect a normal use of the corresponding vanadium redox pile, and reduce the working efficiency of the vanadium redox pile.

Moreover, a vanadium redox battery pile of prior art consists of at least two pile units, and all the pile units overlap with each other. A vanadium redox battery pile comprises a first board and a second frame board. A sealing ring clamping slot is configured on each of the first frame board and the second frame board. A first sealing ring is configured to be received in the sealing ring clamping slot of the first frame board, and a second sealing ring is configured to be received in the sealing ring clamping slot of the second frame board. The ion membrane is disposed between the first frame board and the second frame board. The ion membrane, the first sealing ring and the second sealing ring are formed separately. The ion membrane is fixed by pressing the first sealing ring and the second sealing ring to each other, while the ion membrane is not connected to the sealing ring or the second sealing ring. During use of the vanadium redox battery pile with this mounting structure, the sealing rings and the ion membrane are formed separately, thus electrolyte leakage and mixing of positive and negative electrolytes may happen easily, resulting in decrease of battery pile power and even resulting in battery damages. Then the vanadium redox battery pile is unable to work.

### Summary

It is necessary to develop an integrated assembly having a sealing ring and an ion membrane, so as to increase performance of the vanadium redox battery pile.

The present disclosure provides a method of making an integrated ion membrane sealing ring assembly.

The technical solution of the present disclosure provides a method of making the integrated ion membrane sealing ring assembly, the method includes:

A: mixing sulfonic resin with dimethylformamide based on a ratio of 0.95˜1.05: 90˜98 by weight, and stirring;

B: filtering the mixed liquid obtained in step A;

C: placing the filtrate into a plastic container for precipitating;

D: seating the sealing ring into a worktable of a drying apparatus;

E: pouring the precipitated filtrate into the worktable of the drying apparatus, drying the same under a constant temperature selected between a temperature range of 110° C. to 130° C. for 80 to 100 minutes, and vacuuming while drying under the constant temperature;

F: taking the dried integrated ion membrane sealing ring assembly out of the drying apparatus, and then cooling the assembly.

According to an optimized technical solution of the present disclosure: step A may specifically include: putting sulfonic resin with dimethylformamide based on a ratio of 1: 94.45 by weight into a stainless steel container and mixing; treating the same under a constant temperature of 230° C. and an air pressure of 0.3 MPa˜0.4 MPa for one hour, and stirring based on a revolving speed of 60˜100 revolutions per minute while treating.

According to an optimized technical solution of the present disclosure: the sulfonic resin is perfluorinated sulfonic resin.

According to an optimized technical solution of the present disclosure: in step B, the filtering is carried out by using a titanium-made filter.

According to an optimized technical solution of the present disclosure: step C may specifically include: placing the filtrate in the plastic container and letting the same sit under a constant temperature of 25° C. for 20 days.

According to an optimized technical solution of the present disclosure: the plastic container is transparent or white.

According to an optimized technical solution of the present disclosure: step D may specifically include: seating a bottom side of the sealing ring into a sealing ring clamping slot of the worktable of the drying apparatus; and forming protrusions on a top side of the sealing ring.

According to an optimized technical solution of the present disclosure: step E may specifically include: pouring the precipitated filtrate into the worktable of the drying apparatus, wherein the worktable has a flat face, and sidewalls formed around a periphery of the worktable; drying the precipitated filtrate under a constant temperature of 120° C. for 90 minutes, and vacuuming while drying under the constant temperature, wherein the drying apparatus is an electrical pulse infrared heater.

According to an optimized technical solution of the present disclosure: step F may specifically include: taking the dried integrated ion membrane sealing ring assembly out of the drying apparatus, placing the same on a flat cooling table and cooling under room temperature.

The surface of the ion membrane of the integrated ion membrane sealing ring assembly made by the present disclosure can be substantially smooth and flat, and the flexibility and airtightness of the ion membrane are improved effectively. Thus, the lifetime of the ion membrane can be increased effectively. The ion membrane and the sealing ring are designed as an integrated structure, mounted in the first frame board and the second frame board, and connected and fixed integrally to each other. The mounted ion membrane of the integrated ion membrane sealing ring assembly can be completely smooth and flat and is not easy to dislocate and wrinkle. Moreover, better sealing effect is provided during the use of the integrated ion membrane sealing ring assembly, so as to avoid electrolyte leakage and mixing of positive and negative electrolytes, thereby making the vanadium battery more stable and increasing efficiency of the vanadium redox pile more effectively.

### BRIEF DESCRIPTION OF THE DRAWINGS

FIG. 1 is a flow chart of a method of making an integrated ion membrane sealing ring assembly of the present disclosure.

FIG. 2 is a schematic cross sectional view of a drying apparatus used in the method of making the integrated ion membrane sealing ring assembly of the present disclosure.

FIG. 3 is a side cross-section view after putting the sealing ring in the sealing ring clamping slot of a worktable of the drying apparatus;

FIG. 4 is a side cross-section view after formation of the ion membrane and the sealing ring in the worktable of the drying apparatus.

### DETAILED DESCRIPTION

The followings are in detail to explain technical solutions of the present disclosure based on the drawings.

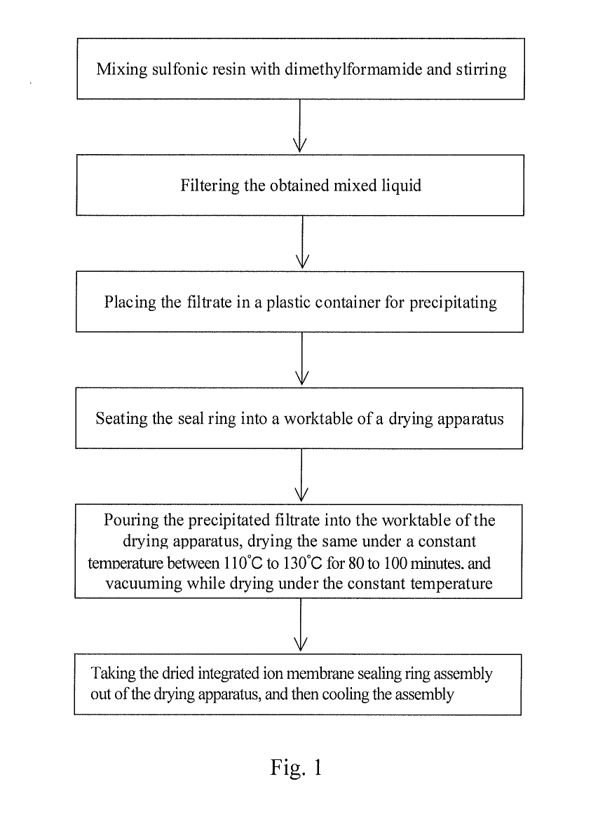

Please refer to a flow chart of a method of making an integrated ion membrane sealing ring assembly of the present disclosure shown in FIG. 1. As shown in FIG. 1, the present disclosure provides a method of making an integrated ion membrane sealing ring assembly. The method includes:

A: mixing sulfonic resin with dimethylformamide based on the a ratio of 0.95˜1.05: 90˜98 by weight, and stirring;

B: filtering the mixed liquid obtained in step A;

C: placing the filtrate into a plastic container for precipitating;

D: seating the sealing ring into a worktable of a drying apparatus;

E: pouring the precipitated filtrate into the worktable of the drying apparatus, drying the same under a constant temperature selected between a temperature range of 110° C. to 130° C. for 80 to 100 minutes, and vacuuming while drying under the constant temperature;

F: taking the dried integrated ion membrane sealing ring assembly out of the drying apparatus, and then cooling the assembly.

In an optimized technical solution of the present disclosure, step A may specifically include: putting sulfonic resin with dimethylformamide based on a ratio of 1: 94.45 by weight into a stainless steel container and mixing; treating the same in a constant temperature of 230° C. and an air pressure of 0.3 MPa˜0.4 MPa for one hour, and stirring based on a revolving speed of 60˜100 revolutions per minute while treating. An optimized selection of the sulfonic resin is perfluorinated sulfonic resin. The selected treating temperature and pressure in step A of the present disclosure are the best values obtained by the inventor(s) through a large number of experiments, not values randomly selected according to common knowledge. It is found by the inventor(s)' experiments that in some embodiments setting a constant temperature of 230° C. as a treating temperature and an air pressure 0.3 MPa˜0.4 MPa determine the final quality of the ion membrane.

In step B, the filtering is carried out by using the titanium-made filter. The main considerations for selecting a titanium-made filter are that chemical components of the titanium materials are more stable and are not easy to react with filtrate chemically.

In the technical solution of the present disclosure, step C may specifically include: placing the filtrate in the plastic container and letting the same sit under a constant temperature of 25° C. for 20 days. The plastic container is transparent or white. The main purposes of selecting a transparent or white container are that it is convenient to observe the precipitating situation in the plastic container at any time and find problems that arise in the precipitating process in time.

In the technical solution of the present disclosure, step D may specifically include: seating a bottom side of the sealing ring into a sealing ring clamping slot of the worktable of the drying apparatus; and forming protrusions on a top side of the sealing ring. To better place the bottom side of the sealing ring into the sealing ring clamping slot of the worktable of the drying apparatus, the bottom side of the sealing ring is therefore designed to be flat. The purpose of forming protrusions on the top side of the sealing ring is to better combine the filtrate obtained in step C with the sealing ring.

In the technical solution of the present disclosure, step E may specifically include: pouring the precipitated filtrate into the worktable of the drying apparatus, wherein the worktable has a flat face, and sidewalls formed around a periphery of the worktable; drying the precipitated filtrate under a constant temperature of 120° C. for 90 minutes, and vacuuming while drying under the constant temperature. The drying apparatus is an electrical pulse infrared heater. The sidewalls are disposed around the worktable such that the worktable of the drying apparatus becomes a small cavity that contains the filtrate, and thereby allows formation of the ion membrane.

Step F may specifically include taking the dried integrated ion membrane sealing ring assembly out of the drying apparatus, and placing the same on a flat cooling table and cooling under a room temperature.

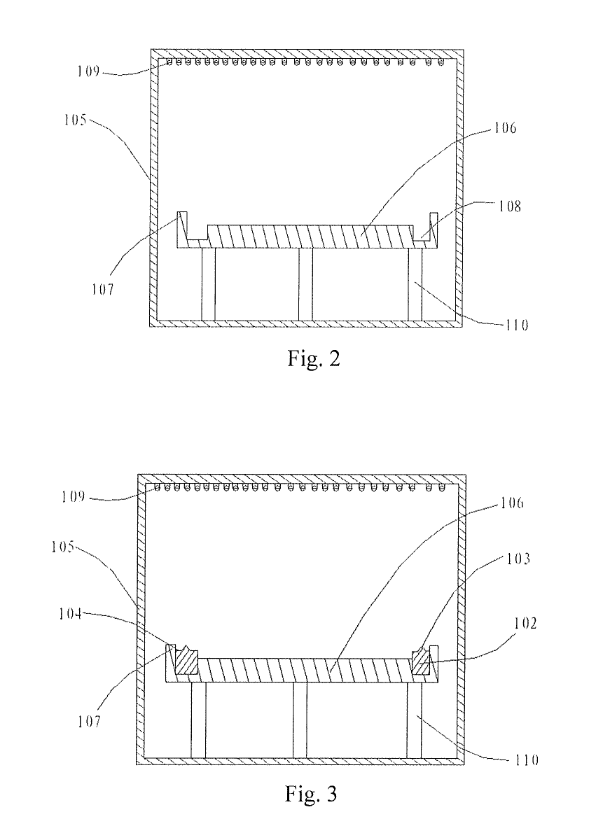

Referring to FIG. 2, a schematic cross sectional view of the drying apparatus used in the method of making an integrated ion membrane sealing ring assembly of the present disclosure is shown. An apparatus for making an integrated ion membrane sealing ring assembly may include a body 105. A worktable 106 is disposed in the body 105. A sidewall 107 is disposed around a periphery of the worktable 106. A sealing ring clamping slot 108 is defined by the sidewall 107. Specifically, the sealing ring clamping slot 108 is formed at an inner edge of the sidewall 107. As shown in FIG. 3, a pillar 110 is formed under the worktable 106. One end of the pillar 110 is connected to the worktable 106, and the other end of the pillar 110 is connected to a bottom wall of the body 105. A heating apparatus 109 is disposed on a top wall of the body 105 and is used to provide heat during formation of an integrated structure of an ion membrane 101 and a sealing ring 102.

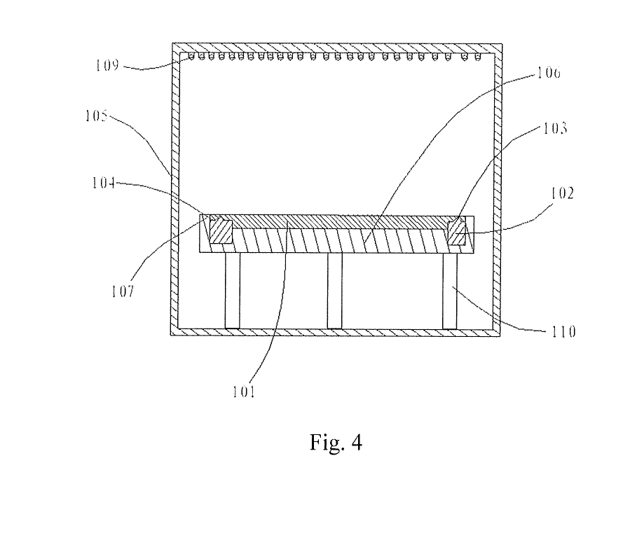

FIG. 3 shows a side cross-section view after putting the sealing ring 102 into the sealing ring clamping slot 108 of the worktable of the drying apparatus and FIG. 4 shows a side cross-section view after formation of the ion membrane and the sealing ring in the worktable of the drying apparatus. As shown in FIG. 3, the sealing ring 102 has been seated into a clamping slot of the worktable 106. A bottom side of the sealing ring 102 is leveled. The sealing ring 102 is clamped in the sealing ring clamping slot 108 of the worktable 106. Protrusions are disposed on the top side 104 of the sealing ring 102 protruding out of the sealing ring clamping slot 108. The upper ends of the protrusions formed on the top side 104 of the sealing ring 102 are positioned at a same level as an upper edge of the sidewall 107 or slightly lower than an upper edge of the sidewall 107.

When using the method of making integrated ion membrane sealing ring assembly of the present disclosure, it needs only to clamp the sealing ring 102 in the sealing ring clamping slot 108 of the worktable 106 in advance, and then pour the precipitated solution for manufacturing the ion membrane in step C into the worktable 106. The sidewall 107 is disposed around the worktable 106, thus a certain amount ion membrane filtrate will be maintained in the worktable 106. At this time, by heating with the heating apparatus 109 configured in the apparatus for making integrated ion membrane sealing ring assembly, the ion membrane filtrate is solidified to a solid structure, wherein the sealing ring and the ion membrane 101 form an integrated structure. The schematic structure is shown in the side cross-section view in FIG. 4.

The surface of the integrated ion membrane sealing ring assembly made by the disclosed technical solution of the present disclosure can be substantially flat and smooth. Also, flexibility and airtightness of the ion membrane can be improved effectively. Thus, the lifetime of the ion membrane can be increased effectively. The ion membrane and the sealing ring are designed as an integrated structure, mounted in the first frame board and the second frame board, and connected and fixed by integrating. The mounted integrated ion membrane sealing ring assembly can be completely flat and smooth and is not easy to dislocate and wrinkle. Moreover, better sealing effect is provided during the use of the integrated ion membrane sealing ring assembly, so as to avoid electrolyte leakage and mixing of positive and negative electrolytes, thereby making the vanadium battery more stable and increasing working efficiency of the vanadium redox pile more effectively.

The above contents are further described in more detail descriptions with specific optimized technical solution for the present disclosure. The specific implementation of the present disclosure should not be limited to just these descriptions. To an ordinary person skilled in the art that the present disclosure belongs to, modifications may be made without departing from the scope of the present disclosure, all of which should be considered as the protection scope of the present invention.

What claimed is:

1. A method of making a sealing ring ion membrane integrated component, wherein: the method of making the sealing ring ion membrane integrated component comprises steps:
A: mixing sulfonic resin with dimethylformamide based on a ratio of 0.95˜1.05: 90˜98, by weight and stirring;
B: filtering the mixed liquid obtained in step A;
C: placing the filtrate in a plastic container for precipitating;
D: seating the sealing ring into a worktable of a drying apparatus;
E: pouring the precipitated filtrate into the worktable of the drying apparatus, drying the same under a constant temperature selected from a temperature range of 110° C. to 130° C. for 80 to 100 minutes, and vacuuming while drying under the constant temperature;
F: taking the dried integrated ion membrane sealing ring assembly out of the drying apparatus, and then cooling the assembly.

2. The method of making a sealing ring ion membrane integrated component of claim 1, wherein:
step A comprises: putting sulfonic resin with dimethylformamide based on a ratio of 1: 94.45 by weight into a stainless steel container and mixing; treating the same under a constant temperature of 230° C. and an air pressure of 0.3 MPa˜0.4 MPa for one hour, and stirring based on a revolving speed of 60˜100 revolutions per minute while treating.

3. The method of making a sealing ring ion membrane integrated component of claim 2, wherein:
the sulfonic resin is perfluorinated sulfonic resin.

4. The method of making a sealing ring ion membrane integrated component of claim 1, wherein:
in step B, the filtering is carried out by using a titanium-made filter.

5. The method of making a sealing ring ion membrane integrated component of claim 1, wherein:
step C comprises: placing the filtrate in a plastic container and letting the same sit under a constant temperature of 25° C. for 20 days.

6. The method of making a sealing ring ion membrane integrated component of claim 5, wherein:
the plastic container is transparent or white.

7. The method of making a sealing ring ion membrane integrated component of claim 1, wherein:
step D comprises: seating a bottom side of the sealing ring into a sealing ring clamping slot of the worktable of the drying apparatus; and forming protrusions on a top side of the sealing ring.

8. The method of making a sealing ring ion membrane integrated component of claim 1, wherein:
step E comprises: pouring the precipitated filtrate into the worktable of the drying apparatus, wherein the worktable has a flat face, and sidewalls formed around a periphery of the worktable; drying the precipitated filtrate under a constant temperature of 120° C. for 90 minutes, and vacuuming while drying under the constant temperature, wherein the drying apparatus is an electrical pulse infrared heater.

9. The method of making a sealing ring ion membrane integrated component of claim 1, wherein:
step F comprises: removing the ion membrane molded by drying, placing the same on a flat cooling table and cooling under room temperature.
